(19) United States
(12) Patent Application Publication
(10) Pub. No.: US 2013/0091131 A1
(43) Pub. Date: Apr. 11, 2013

(54) META-MODEL DISTRIBUTED QUERY CLASSIFICATION

(71) Applicants: JAKUB SZYMANSKI, Seattle, WA (US); LI JIANG, Bellevue, WA (US); ALEKSANDER KOLCZ, San Francisco, CA (US)

(72) Inventors: JAKUB SZYMANSKI, Seattle, WA (US); LI JIANG, Bellevue, WA (US); ALEKSANDER KOLCZ, San Francisco, CA (US)

(73) Assignee: MICROSOFT CORPORATION, Redmond, WA (US)

(21) Appl. No.: 13/267,163

(22) Filed: Oct. 6, 2011

(51) Int. Cl. G06F 17/30

(52) U.S. Cl. 707/731; 707/E17.014

(57) ABSTRACT

Systems and methods are provided for classifying a search query. A first group of query classifiers can be used to evaluate a query relative to various subject matter domains. The evaluation results from the first group of domain classifiers can then be used by a second group of meta-classifiers. The meta-classifiers are associated with meta-classifier categories that may correspond to a domain or that may correspond to a plurality of domains. The assigned meta-classifier category for a query can be used in any convenient manner, such as by triggering additional uses of the search query to match images or other alternative types of documents, or such as by allowing a subject matter domain to be assigned to the query.

### BACKGROUND

Query classification provides a method for improving the relevance of results returned in response to a query. When a query potentially matches several different types of results, query classification can assist in selecting the most likely intent of the person submitting the query. Unfortunately, query classification can be a resource intensive process. Additionally, many queries are potentially related to more than one type of subject matter. Improved methods for assigning such queries to the correct category without requiring excessive additional resources are desirable.

### SUMMARY

In various embodiments, systems and methods are provided for classifying a search query. A first group of query classifiers can be used to evaluate a query relative to various subject matter domains. This initial evaluation provides some type of probability or other score (such as a ranking) for a query relative to the subject matter domains. The evaluation results from the first group of domain classifiers can then be used by a second group of meta-classifiers. The meta-classifiers are associated with meta-classifier categories that may correspond to a domain or that may correspond to a plurality of domains. The meta-classifiers use the data from the first group of domain classifiers to evaluate the query relative to the meta-classifier categories. If the query corresponds to at least one of the meta-classifier categories, the query is assigned to the meta-classifier category with the highest probability or other score. The assigned meta-classifier category can then be used in any convenient manner, such as by triggering additional uses of the search query to match images or other alternative types of documents, or such as by allowing a subject matter domain to be assigned to the query.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

The invention is described in detail below with reference to the attached drawing figures, wherein:

FIG. 1 is a block diagram of an exemplary computing environment suitable for use in implementing embodiments of the present invention.

FIG. 2 schematically shows a network environment suitable for performing embodiments of the invention.

FIGS. 3-5 show examples of methods according to various embodiments of the invention.

### DETAILED DESCRIPTION

### Overview

One of the difficulties with query classification is handling the large number of factors that can be considered while still providing a result on the time scale required for using the query class as a factor in providing search results. One option is to define multiple subject matter domains for classifying documents and/or queries. Multiple processors can then be used in parallel to determine the relevance of a document or query to the plurality of possible domains. In this discussion, a domain is a subject matter category, such as shopping, sports, entertainment, movies, or politics. It is noted that some domains may be subsets of other domains. For example, “movies” may be a subset of “entertainment”, or the two domains can be viewed as unrelated. Other domains can include categories such as images or commerce. Based on the plurality of domains, multiple processors can be used as query classifiers to evaluate the query relative to each domain. The query is then assigned to a domain based on the evaluation by the various processors.

The above strategy allows for analysis of a query relative to various domains on a time scale that is useful providing results in response to the query. However, some queries may appear to be relevant to more than one domain after evaluation. A query that is highly ranked or otherwise evaluated as being relevant to more than one domain can be referred to as an ambiguous query. In a scenario where each domain is handled by separate processors in order to maximize the advantage of parallel evaluation, each processor will be focused on evaluating whether a query belongs to a single domain. Such processors will not necessarily have access to factors that are unrelated to the domain being evaluation. As a result, if more than one domain is ranked highly or otherwise is evaluated as corresponding to a query, none of the query classifiers will have all of the information that would be beneficial for determining how to assign the ambiguous query. Alternatively, none of the query classifiers will have all of the appropriate information to choose between competing evaluations with similar scores.

One option for determining how to assign an ambiguous query is to use a secondary classifier that reviews the output from all of the query classifiers. The output from the query classifiers is aggregated, and the aggregated output is considered by the secondary classifier to assign a query class. Such a secondary classifier may improve the classification for some queries. However, since the secondary processor handles all types of subject matter, it is difficult to train the secondary processor relative to the plurality of available domains.

In various embodiments, an improved method for classifying search queries is provided by using a plurality of meta-classifiers. A first group of query classifiers can be used to evaluate a query relative to various subject matter domains. This initial evaluation by the domain classifiers provides some type of probability or other score (such as a ranking) for a query relative to the domains. The evaluation output or results from the first group of domain classifiers can then be used by a second group of meta-classifiers. The meta-classifiers are associated with subject matter categories that may correspond to a domain, or that may correspond to a plurality of domains. Because the meta-classifiers are limited in scope, the meta-classifiers can be trained to use the output from the domain classifiers in a focused manner. The meta-classifiers use the data from the first group of domain classifiers to evaluate the query relative to the categories corresponding to the meta-classifiers. If the query corresponds to at least one of the meta-classifier categories, the query is assigned to the meta-classifier category with the highest probability or other score. The assigned meta-classifier category can then be used in any convenient manner, such as by triggering additional uses of the search query to match alternative types of documents, such as use of the query in an image search, or by allowing a subject matter domain to be assigned to the query.

### Domain Classifier Operation and Output

When a search query is received, the query can be passed to a plurality of domain classifiers. A domain classifier is a query classifier that determines the relationship of a query to the subject matter corresponding to a single domain. A domain can have various levels of specificity. Some domains can be general, such as a domain corresponding to “news”, while other domains can be more specific, such as a domain corresponding to “news-sports” or a domain corresponding to “news-sports-baseball”. It is noted that having a hierarchical organization for domains is optional, so domains for “news” and “sports” do not necessarily have to be related within a classification scheme.

Depending on the domain classifier, a variety of evaluation factors may be used by a domain classifier to determine if a query is related to a domain. Some evaluation factors can be related to the keywords or other tokens in the query, possibly including the order of the keywords in the query. Other evaluation factors may be related to a search history context for a user that submitted the query. The search history context can include search context from within a current search session or browser session or search context over a longer period of time associated with a user. Still other evaluation factors may be related to a user context, such as a geographic location for a user or demographic data for a user. More generally, any type of factor that is used to match a query to a responsive search result can potentially be an evaluation factor for classifying a query relative to a domain.

By using a plurality of domain classifiers, each domain classifier can be trained to identify queries that are related to the domain for the domain classifier. Because each domain classifier focuses on a single domain, or possibly a limited number of domains, the domain classifiers for different domains can assign differing weights to the various factors that are considered in classifying a query. In some embodiments, the factors considered by a first domain classifier may be different from the factors considered by another domain classifier for a different domain.

By training the domain classifiers for individual subject matter domains, the domain classifiers can provide a series of evaluations for a query relative to each domain. Each evaluation provides a domain evaluation score (or classification score) for a query relative to a domain. The domain evaluation score can be a probability of association for a query with a domain, a ranking value for comparison with other classification scores, or a simple Boolean value. Any other convenient type of value or probability can be used as a domain evaluation score, as well as a combination of values or probabilities. In an alternative embodiment, one or more domains can have multiple domain classifiers. In such an embodiment, each of the domain classifiers for a domain can generate a probability of association and/or a ranking value for a query with the domain. These multiple values can be combined into a classification or evaluation score in any convenient manner.

In addition to domain evaluation scores, a domain classifier can generate additional outputs when evaluating a query. For example, a domain classifier can provide domain evaluation factors that contributed to the evaluation score, such as the factor that provided the largest contribution to the evaluation score, or the top five factors, or another selection of factors. While such evaluation factors are already incorporated into the domain evaluation score, the factors may be useful when comparing domain evaluation scores aggregated from domain classifiers associated with different domains.

After the domain classifiers have evaluated a query relative to various domains, the result is a group of domain evaluation results that include domain evaluation scores. At this stage, some queries can optionally be assigned to a domain. For example, if only one evaluation score is above a threshold value or threshold probability, the query can be assigned to the corresponding domain. However, in various situations, more than one classification score may be above a threshold value and/or threshold probability. In order to assign a query to a query class, a method is needed to distinguish between the potentially matching domains. Alternatively, it may be desirable to always use a subsequent meta-classification step to evaluate a query, regardless of the number of domain evaluation scores that are greater than a threshold value.

### Meta-Classifier Operation and Output

In various embodiments, a plurality of meta-classifiers can be used to assist with assignment of queries to query classes and/or domains. A meta-classifier represents a second level of operation for query classification. A meta-classifier receives as input the evaluation result(s) from some or all of the domain classifiers. Preferably, the output from all of the domain classifiers is used as input for the meta-classifiers. The meta-classifiers then use the aggregated evaluation results to determine a subject matter area for the query. Each meta-classifier provides classification decision information for a specific subject matter area or meta-classifier category. The classification decision information includes a category score for the corresponding meta-classifier category. A meta-classifier category can correspond to a single domain or a plurality of domains. It is noted that a meta-classifier does not need to be available for all domains that are served by a domain classifier. If desired, meta-classifiers can be used for only categories of particular interest. Queries belonging to domains that do not have a corresponding meta-classifier category can be classified using other conventional techniques, such as by performing comparisons on the evaluation results of the domain classifiers.

A meta-classifier differs from conventional multi-layer classifiers in a variety of ways. By using the evaluation results from a plurality of domain classifiers, a meta-classifier can generate classification decision information (including category scores) for a query using a wide range of data without requiring substantial additional resources. The computationally intensive portion of query classification is performed at the domain classifier level. Processing the results from the domain classifiers results in a reduced or minimal amount of consumption of additional processor time. A meta-classifier uses context information from domains outside of the or category for which the meta-classifier will provide a category score. Thus, the meta-classifier makes use of an expanded range of information in determining decision information related to classification. Additionally, a portion of the input received by a meta-classifier corresponds to the subject matter area or domain(s) for which the meta-classifier provides classification decision information. Thus, the meta-classifier is different from conventional domain transfer classifiers.

In some embodiments, all available meta-classifiers can receive the aggregated output from all available domain classifiers. This allows each meta-classifier to start with the same data. Each meta-classifier, however, can assign different weights to the output information from the domain classifiers. This allows the meta-classifiers to be trained individually to arrive at query classification decisions. The meta-classifiers can be trained using evaluation results from domain classifiers in a conventional manner.

As an initial step, the evaluation results from the domain classifiers are aggregated. The aggregation can take place on each meta-classifier, or the evaluation output can be aggregated first and then distributed to the one or more meta-classifiers. Still other aggregation options can be used that allow the meta-classifiers to receive evaluation information from at least a plurality of the domain classifiers. The evaluation information from each domain classifier can include a probability of association with the domain, a ranking score for the domain, or a combination thereof. Additionally, the evaluation information can include one or more evaluation factors used by the domain classifiers to determine the probability and/or ranking score. For example, the additional one or more evaluation factors can be provided with identifiers indicating the nature of the corresponding factor. Alternatively, the additional factors can be provided as part of an array of factor values, where the position of the factor in the array indicates the identity or nature of the factor. Optionally, such an array of factor values may be sparsely populated, with only a few of the array values corresponding to a non-zero value.

After receiving the evaluation information from the domain classifiers, each meta-classifier can use the aggregated evaluation information to generate classification decision information for a query relative to the category for the meta-classifier. The meta-classifier can generate a probability value or other category score that indicates the association of a query with a subject matter area. The category scores from the meta-classifiers can then be compared. If none of the category scores is above a threshold value, then the query is not associated with any of the meta-classifier categories. If at least one of the category scores is above a threshold value, the query can be assigned to a domain within the meta-classifier category that corresponds to the highest category score. If a meta-classifier corresponding to a highest category score is associated with multiple domains, the outputs from the domain classifiers may be used to select a domain within the meta-classifier domains. For example, a meta-classifier may have a subject matter area of “commerce”, which represents a query that indicates a user who intends to purchase something. In this example, the subject matter area of “commerce” can correspond to two domains. One domain is a “shopping-electronics” domain, which includes a variety of software and computer hardware products. This area also includes items such as music downloads, electronic books, and other items that can be downloaded via a network. The other domain is a “shopping-general” domain. If the “commerce” meta-classifier generates the highest meta-classifier category score, the query will be assigned to one of the domains within the commerce subject matter area. The domain evaluation scores from the domain classifiers for “shopping-electronics” and “shopping-general” are then used to assign the query to one of the domains within the commerce category.

Assigning a query to a subject matter domain or a meta-classifier category can result in a number of actions. The assignment of a query to a category can be used as part of the process for identifying results that are responsive to the query. For example, based on the assigned query class, the results identified for a query can be refined to give a higher probability to results within the assigned query class.

In other embodiments, assigning a query to a meta-classifier category can result in the query being processed in additional and/or different manners than a conventional query. One option is to use the meta-classifier assignment to initiate special interfaces. In the “commerce” example above, a query was assigned to a subject matter area that involved two types of shopping domains. In such an example, based on the assignment first to the commerce category, and then the “shopping-electronics” domain, a specialized shopping interface can be displayed to the user. A similar behavior could be used for assignment to other subject matter areas, such as when a query is assigned to a subject matter area corresponding to travel or entertainment.

Still another option can be to use assignment to a meta-classifier subject area to trigger additional types of searching. For example, a meta-classifier can be associated with a subject matter area corresponding to “images”. When a query is assigned to the images subject matter area, this represents a query where the user's intent is to find an image as the search result. Assignment to the images category can result in submitting the query to one or more additional search engines for performing image based searches. Optionally, the query can be modified to improve the query results in the image based search engines. Alternatively, matching a query to a subject matter area of “travel” could trigger a different type of handling for a query. A travel query parser could be used to match the query terms to one or more templates for extraction of information such as an origination and/or destination city or a type of desired travel (such as plane or train).

### Example of Operation of Meta-Classifiers

The following are prophetic examples of operation of a system using both domain classifiers and meta-classifiers to perform query classification. In the following examples, a query classification system involves a first layer of 100 domain classifiers. The domain classifiers operate on dedicated processors to generate evaluation information for a query relative to a domain. The domains include a variety of topics, including news, sports, weather, health, home improvement, celebrities. Some domains represent sub-categories of other domains. Thus, in addition to the domain for “news”, there is a domain for “news-politics.” Additional domains correspond to various types of entertainment activities, such as domains for dining, movies, live performances, and sporting events. Still other domains include domains for shopping-electronics, shopping-vehicle, and shopping-general. Additionally, several domains are available that represent categories that may intersect with other domains. These domains include categories for travel, images, and videos.

In addition to the domain classifier layer, additional processors are used for a second meta-classifier layer. The meta-classifier layer contains 5 meta-classifiers, as opposed to the 100 domain classifiers. Three of the meta-classifiers correspond to the images, videos, and travel domains. A fourth meta-classifier corresponds to the subject matter area of commerce, and corresponds to the three shopping domains (electronics, automotive, general). The remaining meta-classifier represents an entertainment category, and corresponds to the domains for dining, movies, live performances, and sporting events. If desired, the meta-classifier layer could include enough meta-classifiers so that each domain corresponds to one of the meta-classifier categories.

One or more sets of training documents, such as one or more sets of labeled queries, are initially used to train the domain classifiers for query evaluation relative to each of the respective domains. In this example, the domain classifiers are designed to provide a probability of association between a query and a domain. For the search engine used in this example, it has been determined that the search engine provides improved results when queries can be assigned to a query category, even if the assignment is somewhat speculative. As a result, a domain threshold level is set for the domain classifiers of 30%. If a domain classifier provides an association probability of lower than 30%, then the query is determined to not be associated with that domain. If at least one value is greater than 30%, the probabilities from the domain classifiers are further compared in order to assign the query to a domain. The further comparison can correspond to a comparison of probabilities between domain classifiers, or the further comparison can correspond to a comparison of scores or probabilities calculated by meta-classifiers. In the following examples, regardless of the probability generated by a domain classifier, the evaluation results from all domain classifiers is aggregated for use by the meta-classifiers during query classification.

After training the domain classifiers, the meta-classifiers are also trained. The meta-classifiers can be trained using the same types of document sets as the domain classifiers. The documents are first evaluated by the domain classifiers to generate domain evaluation scores. The evaluation scores are then aggregated for use by each meta-classifier. In this example, the meta-classifiers are designed to provide a probability of association between a query and a meta-classifier category. Because some domains do not have a corresponding meta-classifier, queries with a marginal association should not necessarily be associated with a meta-classifier category. As a result, a meta-classifier threshold level is set at 50%. If a meta-classifier provides an association probability of lower than 50%, then the query is determined to not be associated with the corresponding meta-classifier category. If at least one category score is greater than 50%, the meta-classifier with the highest probability (or other category score) is used to assign the query. After training, the query classification system (including the domain classifiers and the meta-classifiers) is ready for use in assigning queries to subject matter and/or domains.

### EXAMPLE 1

In a first prophetic example, a user can enter a search query of “Jordan basketball”. As part of processing for this query, the query classification system is used to determine a query class. First, the query is processed by each of the domain classifiers. Several of the domain classifiers provide a probability of greater than 30%, including domain classifiers for sports, sports-basketball, news-international, and images. The highest probability corresponds to sports-basketball. The evaluation results from all of the classifiers are then aggregated and passed to the meta-classifiers. Because of the somewhat ambiguous nature of the query, none of the meta-classifiers generates a score of greater than 50%. As a result, the highest value from the domain classifiers is used to assign a domain of sports-basketball for the query. This assigned domain is used by a search engine as part of the information for identifying and/or ranking responsive results. Alternatively, if domains are not identical to query classes, the assigned domain could be converted to a query class prior to forwarding the domain to the search engine. A listing of the highest ranking responsive results are then returned by the search engine for display to the user.

After viewing the results provided by the search engine, the user modifies the search query to “Jordan basketball dunk” and submits the query again. The same domains of sports, sports-basketball, news-international, and images are evaluated by the domain classifiers as having an association probability of greater than 30%. Once again, the domain of sports-basketball is identified as the highest probability domain. The aggregated output from the domain classifiers is then passed to the meta-classifiers. Based on the additional term, the meta-classifier for the subject matter “images” generates a probability of greater than 50%.

Because the images probability is greater than the threshold value and is the highest meta-classifier value, the category “images” and the domain “images” are assigned to the query. The domain “images” is used by the primary search engine for identifying responsive results. Additionally, the assignment to the “images” category by the meta-classifier initiates a secondary search. The search query is modified to adapt the query for use in an image search engine. The image search engine identifies primarily image and/or video based results. Based on the modified search query, the image search engine provides a second set of responsive results. The results from the primary search engine and the secondary (image) search engine are displayed to a user. The search results from the image search engine are displayed in a separate portion of a display area to the user.

### EXAMPLE 2

Later during the search session, the user submits a query of “cannon quality review.” After processing by the domain classifiers, no domain has a probability greater than 30%. The output from the domain classifiers is aggregated and passed to the meta-classifiers. The meta-classifiers also do not generate a probability greater than a threshold value. As a result, no category, domain, or query class is assigned. The query is processed by the search engine without a domain or query class assignment.

The user then refines the query to “cannon picture quality”. During pre-processing of the query, the search engine modifies the query to substitute the name of a camera maker for the first term. The query as modified by the pre-processor is then processed by the domain classifiers. Probabilities greater than the threshold value of 30% are calculated for domains related to shopping-electronics and images. The aggregated results are then passed to the meta-classifier processors. A value greater than 50% is generated for both the category “commerce” and the category “images.” Because the probability is higher for the category corresponding to commerce, the commerce category is associated with the query. Several domains correspond to commerce, including the domain for shopping-electronics. As shopping-electronics is the highest rated domain corresponding to the commerce subject matter, shopping-electronics is assigned as the domain for the query. Additionally, a separate commerce interface is launched on the display of the user. The separate commerce interface can, for example, be launched in a new browser window. The pre-processed search query is used in a commerce search engine to provide responsive results within the format of the commerce interface. Optionally, conventional search results can also be provided based on the primary search engine.

### ADDITIONAL EXAMPLES

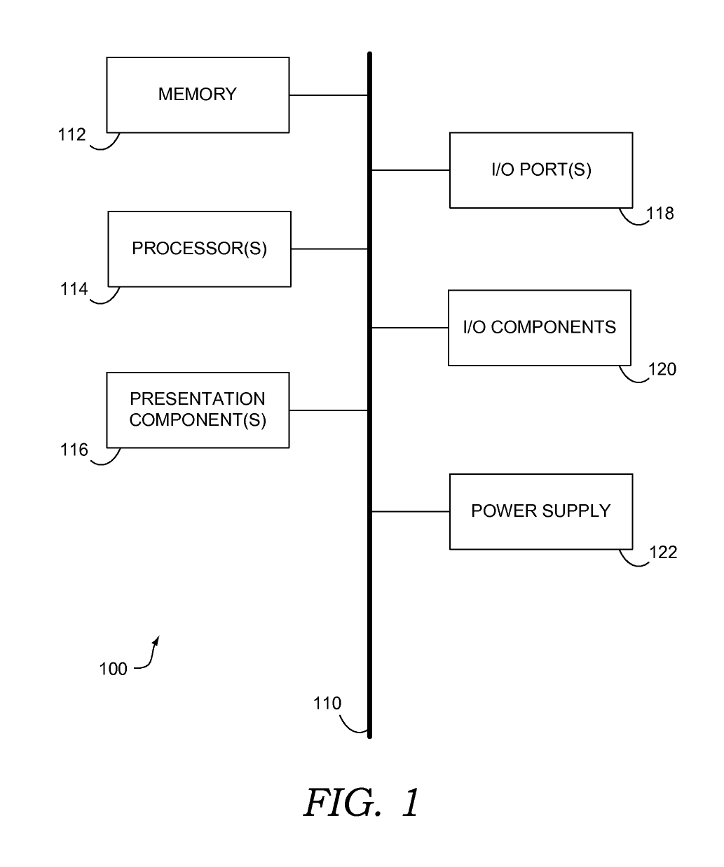

Having briefly described an overview of various embodiments of the invention, an exemplary operating environment suitable for performing the invention is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, and the like. The invention may also be practiced in distributed computing environments where tasks are performed by remote-processing devices that are linked through a communications network.

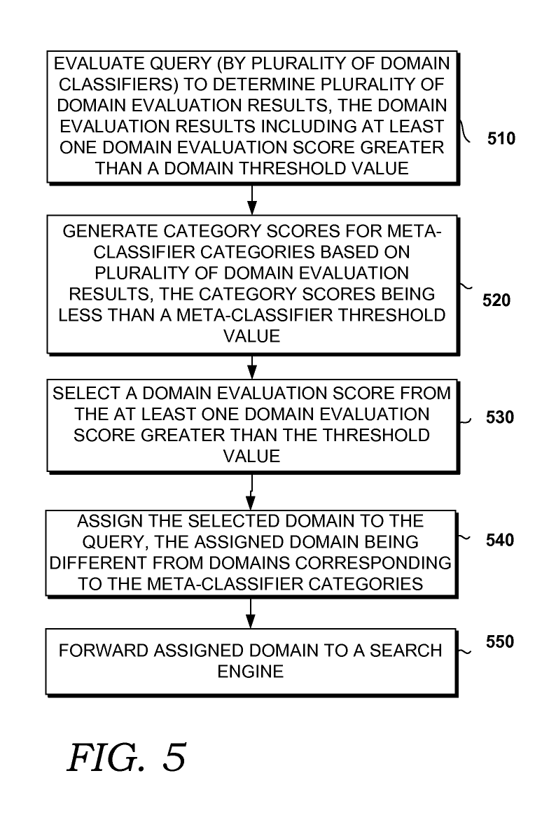

With continued reference to FIG. 5, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 5 and reference to “computing device.”

The computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 100. In an embodiment, the computer storage media can be selected from tangible computer storage media. In another embodiment, the computer storage media can be selected from non-transitory computer storage media.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The memory 112 can include computer-storage media in the form of volatile and/or nonvolatile memory. The memory may be removable, non-removable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 can allow the computing device 100 to be logically coupled to other devices including the I/O components 120, some of which may be built in. Illustrative components can include a microphone, joystick, game pad, satellite dish, scanner, printer, wireless device, etc.

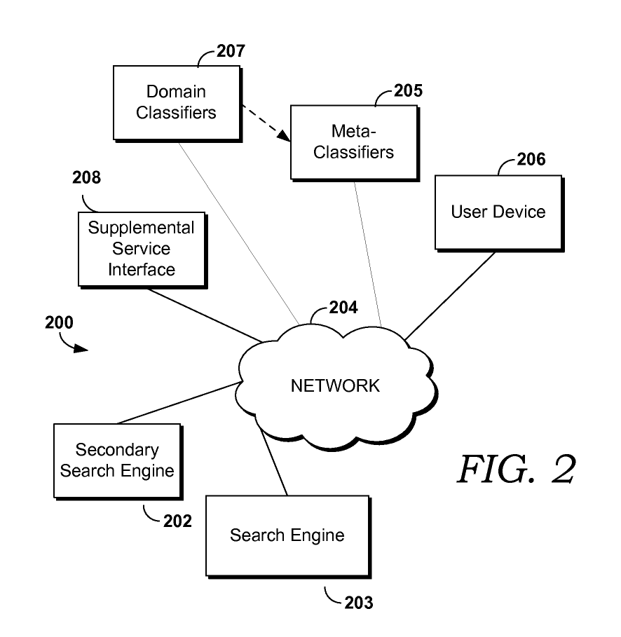

With additional reference to FIG. 2, a block diagram depicting an exemplary network environment 200 suitable for use in embodiments of the invention is described. The environment 200 is but one example of an environment that can be used in embodiments of the invention and may include any number of components in a wide variety of configurations. The description of the environment 200 provided herein is for illustrative purposes and is not intended to limit configurations of environments in which embodiments of the invention can be implemented.

The environment 200 includes a network 204, a user device 206, a search engine 203, and a secondary search engine 202. The environment also includes a plurality of domain classifiers 207, a plurality of meta-classifiers 205, and a component for providing a supplemental service interface 208. The network 204 includes any computer network such as, for example and not limitation, the Internet, an intranet, private and public local networks, and wireless data or telephone networks. The user device 206 can be any computing device, such as the computing device 100, from which a search query can be provided. For example, the user device 206 might be a personal computer, a laptop, a server computer, a wireless phone or device, a personal digital assistant (PDA), or a digital camera, among others. In an embodiment, a plurality of user devices 206, such as thousands or millions of user devices 206, can be connected to the network 204. The search engine 203 includes any computing device, such as the computing device 100, and provides functionalities for a content-based search engine. Secondary search engine 202 can be a conventional search engine similar to search engine 203, or secondary search engine can be adapted for searching a specific type of subject matter, such as images, videos, travel, or commerce. When a search query is received form a user device 206, the query is passed to domain classifiers 207 for evaluation. The evaluation results from domain classifiers 207 can be passed to meta-classifiers 205 via network 204, or the domain classifiers 207 can have a direct link with meta-classifiers 205 as shown by the dotted-line arrow. When a meta-classifier category is assigned to a query, the assignment can optionally initiate a search using secondary search engine 202 and/or initiate a supplemental service interface 208 for display of a service on user device 206, such as a shopping service interface.

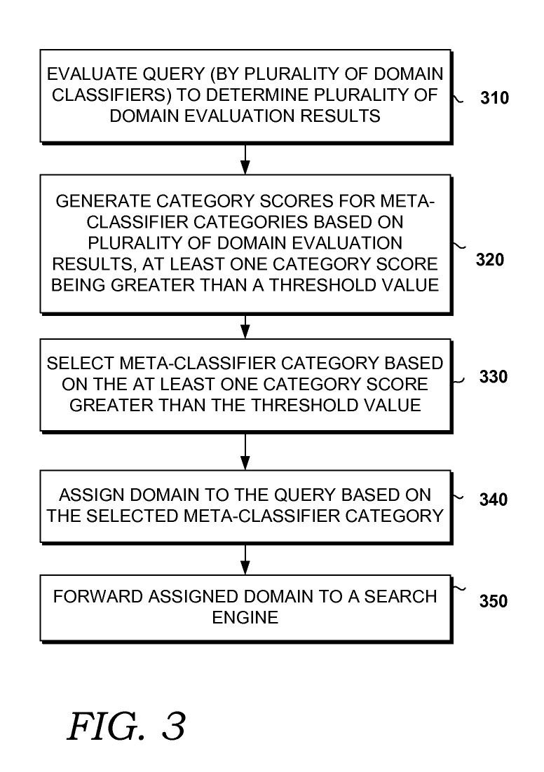

FIG. 3 shows an example of a method according to the invention. In FIG. 3, a query is evaluated 310 by a plurality of domain classifiers. The query is evaluated to determine a plurality of domain evaluation results. Category scores are generated 320 for meta-classifier categories based on the plurality of domain evaluation results. In the embodiment shown in FIG. 3, at least one category score is greater than a threshold value. A meta-classifier category is then selected 330 based on the at least one category score that is greater than the threshold value. A domain is assigned 340 to the query based on the selected meta-classifier category. The assigned domain is then forwarded 350 to a search engine, such as for use in identifying responsive results.

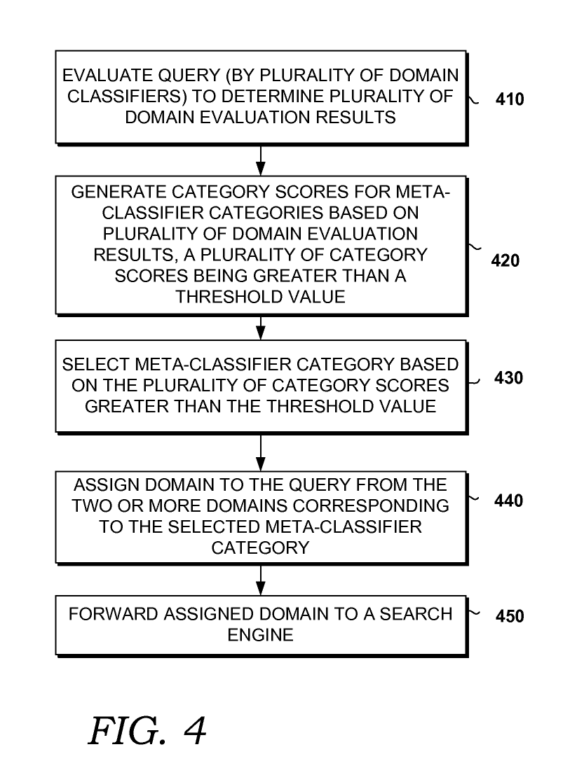

FIG. 4 shows another example of a method according to the invention. In FIG. 4, a query is evaluated 410 by a plurality of domain classifiers. The query is evaluated to determine a plurality of domain evaluation results. Category scores are generated 420 for meta-classifier categories based on the plurality of domain evaluation results. In the embodiment shown in FIG. 4, a plurality of the category scores are greater than a threshold value. A meta-classifier category is then selected 430 based on the plurality of category scores that are greater than the threshold value. In the embodiment shown in FIG. 4, the selected category corresponds to two or more domains. A domain is assigned 440 to the query based on the selected meta-classifier category. The assigned domain is a domain that corresponds to the meta-classifier category. The assigned domain is then forwarded 450 to a search engine, such as for use in identifying responsive results.

FIG. 5 shows another example of a method according to the invention. In FIG. 5, a query is evaluated 510 by a plurality of domain classifiers. The query is evaluated to determine a plurality of domain evaluation results. The domain evaluation results include domain evaluation scores, and at least one domain evaluation score is greater than a domain threshold value. Category scores are generated 520 for meta-classifier categories based on the plurality of domain evaluation results. In the embodiment shown in FIG. 5, none of the category scores are greater than a meta-classifier threshold value. A domain evaluation score is then selected 530 from the at least one domain evaluation score that is greater than the domain threshold value. A domain is assigned 540 to the query based on the selected domain evaluation score. The assigned domain is different from domains that correspond to a meta-classifier category. The assigned domain is then forwarded 550 to a search engine, such as for use in identifying responsive results.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

What is claimed is:

1. A computer-implemented method for classifying a query, comprising:
evaluating a query, by a plurality of domain classifiers, to determine a plurality of domain evaluation results, the plurality of domain classifiers corresponding to a plurality of domains;
generating category scores for two or more meta-classifier categories based on the plurality of domain evaluation results, at least one generated category score being greater than a threshold value;
selecting a meta-classifier category based on the at least one generated category score;
assigning a domain to the query based on the selected meta-classifier category, the assigned domain being included within the selected meta-classifier category; and
forwarding the assigned domain to a search engine.

2. The computer-implemented method of claim 1, further comprising initiating a secondary search based on the selected meta-classifier category.

3. The computer-implemented method of claim 2, wherein the secondary search comprises an image search.

4. The computer-implemented method of claim 1, further comprising initiating a supplemental user interface based on the selected meta-classifier category.

5. The computer-implemented method of claim 1, wherein forwarding the assigned domain to a search engine comprises:
assigning a query class to the received query based on the assigned domain; and
forwarding the assigned query class to the search engine.

6. The computer-implemented method of claim 1, further comprising determining responsive results for the received query, the determining being performed by the search engine after receiving the assigned domain.

7. The computer-implemented method of claim 1, wherein the domain evaluation results comprise domain evaluation scores and one or more domain evaluation factors.

8. The computer-implemented method of claim 7, wherein the domain evaluation scores comprise a probability, a ranking value, or a combination thereof.

9. The computer-implemented method of claim 7, wherein a domain evaluation score for the assigned domain is less than at least one other domain evaluation score.

10. The computer-implemented method of claim 1, wherein at least one meta-classifier category corresponds to two or more domains of the plurality of domains.

11. The computer-implemented method of claim 1, wherein generating category scores based on the plurality of domain evaluation results comprises:
aggregating domain evaluation results from each domain classifier; and
generating category scores based on the aggregated domain evaluation results.

12. One or more computer-storage media storing computer-useable instructions that, when executed by a computing device, perform a method for classifying a query, comprising:
evaluating a query, by a plurality of domain classifiers, to determine a plurality of domain evaluation results, the plurality of domain classifiers corresponding to a plurality of domains;
generating category scores for two or more meta-classifier categories based on the plurality of domain evaluation results, a plurality of the generated category scores being greater than a threshold value;
selecting a meta-classifier category based on the plurality of generated category scores, the selection being based on a comparison of the plurality of generated category scores, the selected meta-classifier category corresponding to two or more domains from the plurality of domains;
assigning a domain to the query from the two or more domains corresponding to the meta-classifier category; and
forwarding the assigned domain to a search engine

13. The computer-storage media of claim 12, wherein the domain evaluation results include domain evaluation scores, and wherein assigning a domain to a query further comprises assigning a domain corresponding to the selected meta-classifier category based on a comparison of domain evaluation scores from the two or more domains corresponding to the selected meta-classifier category.

14. The computer-storage media of claim 12, wherein the domain evaluation results comprise domain evaluation scores and one or more domain evaluation factors.

15. The computer-storage media of claim 14, wherein the domain evaluation scores comprise a probability, a ranking value, or a combination thereof.

16. The computer-storage media of claim 14, wherein generating category scores based on the plurality of domain evaluation results comprises generating category scores based on at least one domain evaluation factor.

17. The computer-storage media of claim 12, wherein forwarding the assigned domain to a search engine comprises:
assigning a query class to the received query based on the assigned domain; and
forwarding the assigned query class to the search engine.

18. The computer-storage media of claim 12, further comprising determining, by the search engine after receiving the assigned domain, responsive results for the received query.

19. The computer-storage media of claim 12, wherein generating category scores based on the plurality of domain evaluation results comprises:
aggregating domain evaluation results from each domain classifier; and
generating category scores based on the aggregated domain evaluation results.

20. A computer-implemented method for classifying a query, comprising:
evaluating a query, by a plurality of domain classifiers, to determine a plurality of domain evaluation results, the plurality of domain classifiers corresponding to a plurality of domains, the domain evaluation results including a domain evaluation score, at least one domain evaluation score being greater than a domain threshold value;
generating category scores for a plurality meta-classifier categories based on the plurality of domain evaluation results, the plurality of meta-classifier categories corresponding to a plurality of domains, the generated category scores being less than a meta-classifier threshold value;
selecting a domain evaluation score from the at least one domain evaluation score greater than the domain threshold value;
assigning the selected domain to the query, the assigned domain being different from the domains corresponding to the plurality of meta-classifier categories; and
forwarding the assigned domain to a search engine.
